(19) United States
(12) Patent Application Publication
(10) Pub. No.: US 2019/0244162 A1
(43) Pub. Date: Aug. 8, 2019

(54) METHOD AND SYSTEM FOR CROWD-SOURCED INVENTORY CONTROL ADJUSTMENTS

(71) Applicant: MAPSTED CORP., Mississauga (CA)

(72) Inventors: Paramvir Singh Nagpal, Brampton (CA); Saeedeh Hamidifar, Mississauga (CA)

(73) Assignee: MAPSTED CORP., Mississauga (CA)

(21) Appl. No.: 15/888,077

(22) Filed: Feb. 4, 2018

(51) Int. Cl. G06Q 10/08; G06Q 30/02; H04W 4/021; H04W 4/029; H04W 4/35; H04W 4/33; H04L 29/08

(52) U.S. Cl. CPC G06Q 10/087; G06Q 30/0215; G06Q 30/0223; H04W 4/021; G06Q 30/0239; H04W 4/35; H04W 4/33; H04L 67/26; H04W 4/029

(57) ABSTRACT

A method and system for adjusting an inventory control record associated with an inventory item subject to inventory control tracking within a bounded area. The method, executed in a processor of a server computing device, comprises receiving, from at least a first mobile device located within the bounded area, at least a first data value associated with the inventory item, localizing, using the processor, the at least a first mobile device to a first location within the bounded area based on accessing a fingerprint data mapping of the bounded area, comparing, using the processor, the at least a first data value and the first location with a set of data values of the inventory control record associated with the inventory item, designating the inventory item as an outlier inventory item based on the comparing, and adjusting the inventory control record in conformance with the designating, the at least a first data value, and the first location.

### BACKGROUND

Users of mobile devices are increasingly using and depending upon indoor positioning and navigation applications and features. Seamless, accurate and dependable indoor positioning can be difficult to achieve using satellite-based navigation systems when the latter becomes unavailable or sporadically available, such as within enclosed or partly enclosed urban infrastructure and buildings, including stores, wareouses, hospitals, shopping malls, airports, and universities. To address this problem, indoor navigation solutions may rely on sensors including accelerometers, gyroscopes, and magnetometers which may be commonly included in mobile phones and other mobile computing devices, to localize such mobile devices within an indoor positioning accuracy of around one meter or better.

### BRIEF DESCRIPTION OF THE DRAWINGS

FIG. 1 illustrates, in an example embodiment, a system for deploying crowd-sourced inventory control adjustments.

FIG. 2 illustrates an example architecture of a computing and communication mobile device used in deploying crowd-sourced inventory control adjustments.

FIG. 3 illustrates an example architecture of a server computing device used in deploying crowd-sourced inventory control adjustments.

FIG. 4 illustrates, in an example embodiment, a method of operation of a crowd-sourced inventory control adjustment system.

### DETAILED DESCRIPTION

Among other benefits and technical effect, embodiments provided herein alleviate inaccuracies in inventory control systems as result of lost or damaged inventory items within an area subject to inventory control processes and records, thereby enabling more accurate accounting for same. More specifically, in a crowd sourcing-based approach, users provided with, or carrying, an indoor positioning mobile device application, and may be encouraged to scan inventory items in a store or warehouse, such as for price discovery purposes. Upon scanning of an inventory item by a carried mobile device having input/output functionality including barcode or RFID reader capability, the mobile device position may be determined, or localized as referred to herein, such as by accessing fingerprint data mapping correlated with sequential positions along a mobile device trajectory, or trajectory segment, using wireless communication signal signatures and sensor readings acquired by the carried mobile device along the route that a user's mobile device traverses while within the fingerprint-mapped area. The localized position of the mobile device may be taken as the actual location of the item scanned, where such actual location may or may not coincide with a nominal, or pre-designated, location for that item. The inventory control record for a given item may specify, such as in one or more data fields of the inventory record unique to that item, that nominal, expected or pre-designated location. In this manner, a mobile device user scanning an inventory item, for any one of multiple possible reasons, may contribute, albeit relatively passively, to tracking accurate and updated positions of inventory items within the indoor location such as a warehouse building or store.

In particular, the crowd sourcing-based embodiments described herein may advantageously minimize the need for dedicated store employees to laboriously track individual items which may be mis-located or damaged as non-conforming to quality standards, within the indoor venue, and thereby result in more accurate inventory control records. User incentives may be offered, for instance, to encourage random mobile device users and customers to participate using their mobile device indoor navigation application.

Further in regard to the fingerprint data mapping of the area, which may be an indoor or at least partially bounded area, the majority of indoor navigation systems require some form of fingerprint data mapping for a particular facility prior to deployment. The term fingerprint, variously referred to herein as fingerprint data, in one embodiment constitutes any combination of time-correlated, individual measurements of received wireless communication signal strength information, magnetic field information (strength, direction) or barometric pressure information at known, fixed locations within an area, including an indoor area. In other words, a fingerprint includes a correlation of sensor and signal information (including, but not necessarily limited to wireless signal strength, magnetic or barometric information inertial sensor information) at a given instance in time, at a unique position along a sequence of positions that constitute a navigation path traversed by the mobile device. Additionally, given that sampling times and sampling rates applied to particular device sensors may be different, the signal and sensor information as measured may be time-averaged across particular periods of time, with the time-averaged value being used to represent the signal information at any given instance of time within that particular period of time in which the signal information is time-averaged.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processor and memory resources. For example, one or more embodiments described herein may be implemented, in whole or in part, on computing devices such as servers, desktop computers, mobile devices including cellular or smartphones, laptop computers, wearable devices, and tablet devices. Memory, processing, and network resources may all be used in connection with the establishment, use, or performance of any embodiment described herein, including with the performance of any method or with the implementation of any system.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable memory storage units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Provided herein is a method and system for adjusting an inventory control record associated with an inventory item subject to inventory control tracking within a bounded area. The method, executed in a processor of a server computing device, comprises receiving, from at least a first mobile device located within the bounded area, at least a first data value associated with the inventory item, localizing, using the processor, the at least a first mobile device to a first location within the bounded area based on accessing a fingerprint data mapping of the bounded area, comparing, using the processor, the at least a first data value and the first location with a set of data values of the inventory control record associated with the inventory item, designating the inventory item as an outlier inventory item based on the comparing, and adjusting the inventory control record in conformance with the designating, the at least a first data value, and the first location.

A server computing system for adjusting an inventory control record associated with an inventory item subject to inventory control tracking within a bounded area is also provided. The server system comprises a processor, and a memory storing a set of instructions. The instructions are executable in the processor to receive, from at least a first mobile device located within the bounded area, at least a first data value associated with the inventory item, localize, using the processor, the at least a first mobile device to a first location within the bounded area based on accessing a fingerprint data mapping of the bounded area, compare, using the processor, the at least a first data value and the first location with a set of data values of the inventory control record associated with the inventory item, designate the inventory item as an outlier inventory item based on the comparing, and adjust the inventory control record in conformance with the designating, the at least a first data value, and the first location.

### System Description

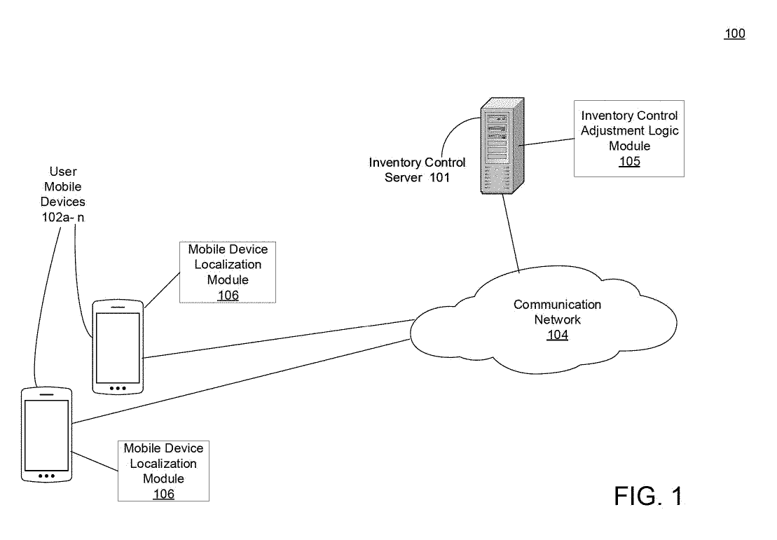

FIG. 1 illustrates, in an example embodiment, a system for deploying crowd-sourced inventory control adjustments. Inventory control server 101, also referred to herein as server 101, includes inventory control adjustment logic module 105, and is communicatively connected via communication network 104 to a plurality of computing and communication mobile devices 102a-n, also referred to herein as mobile device(s) 102a-n. As used herein, a singular mobile device of the plurality of mobile devices 102a-n may be referred to as mobile device 102. Mobile devices 102a-n may include mobile device localization module 106, which in one embodiment, may be included in a locality positioning, or indoor navigation, software application downloaded and installed at individual ones of mobile devices 102a-n.

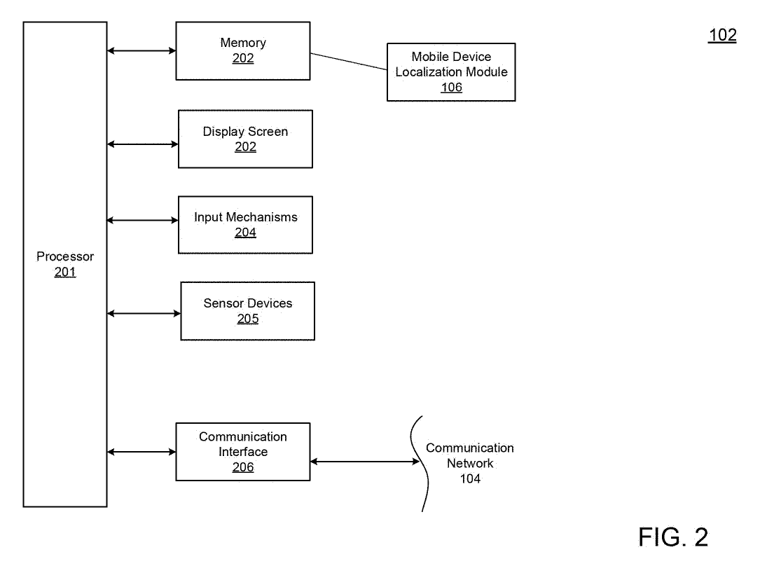

FIG. 2 illustrates an example architecture 102 of computing and communication mobile devices 102a-n used in deploying crowd-sourced inventory control adjustments. As used herein, the term mobile device 102 refers to any singular mobile device among mobile devices 102a-n. In one embodiment, mobile device 102 may correspond to, for example, a cellular communication device (e.g., smartphone, tablet, etc.) that is capable of any one or more of telephony, messaging, and data computing services. In variations, mobile device 102 can correspond to, for example, a tablet or a wearable computing device. Mobile device 102 may include processor 201, memory 202, display screen 203, input mechanisms 204 such as a keyboard or software-implemented touchscreen input functionality, barcode, Quick Response (QR) code or other symbol- or code-scanner input functionality, including a camera in conjunction with optical character recognition-based functionality to convert text and other images into digital data. Mobile device 102 may include sensor functionality by way of sensor devices 205. Sensor devices 205 may include any of inertial sensors (accelerometer, gyroscope), magnetometer or other magnetic field sensing functionality, and barometric or other environmental pressure sensing functionality. Mobile device 102 may also include capability for detecting and communicatively accessing wireless communication signals, including but not limited to any of Bluetooth, Wi-Fi, RFID, and GPS signals. Mobile device 102 further includes the capability for detecting and measuring a received signal strength of the wireless communication signals. In particular, mobile device 102 may include location determination capability such as by way of GPS module 205, and communication interface 206 for communicatively coupling to communication network 104, such as by sending and receiving cellular data over data channels and voice channels.

Mobile device localization module 106 includes instructions stored in memory 202 of mobile device 102. In embodiments, mobile device localization module 106 may be included in a mobile device navigation application program stored in memory 202 of mobile device 102, which in conjunction with at least some sub-modules of inventory control logic module 105, may be used for localizing mobile device 102. The bounded area may be an indoor area within a shopping mall, an airport, a commercial store, a warehouse, a university, or an at least partially enclosed building. Acquisition of the fingerprint data may be automatically triggered at respective ones of mobile devices 102a-n upon an event occurrence. The event occurrence may include, but not necessarily limited to, a user of mobile device 102 scanning a barcode, using such as a Quick Response (QR) code or an RFID tag, of an inventory item within the bounded area. Acquisition of the fingerprint data for localizing a user's mobile device 102 may thus be automatically triggered upon the event occurrence within the area.

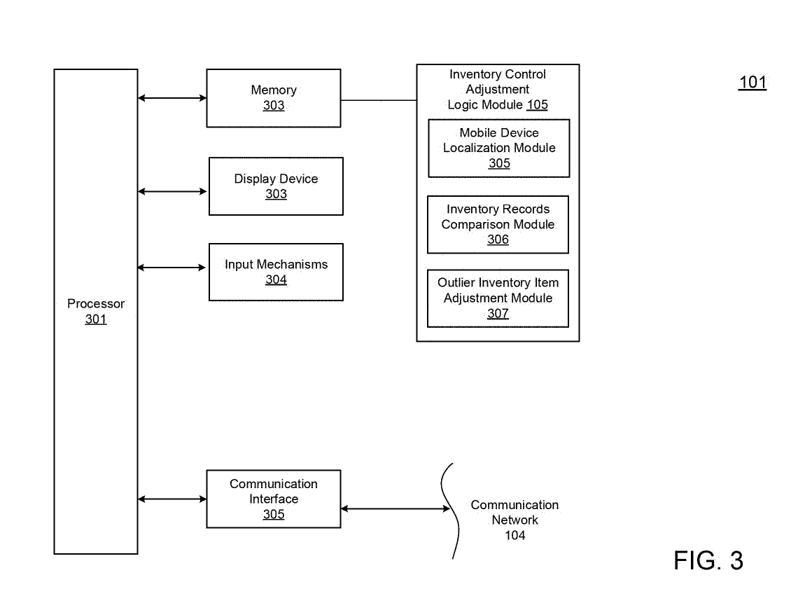

FIG. 3 illustrates an example architecture of server computing device 101, which may be an inventory control server 101 in one embodiment, for deploying crowd-sourced inventory control adjustments. Server 101, which in an embodiment architecture may be implemented on more than one communicatively linked server devices, may include processor 301, memory 302 which may include a read-only memory (ROM) as well as a random access memory (RAM) or other dynamic storage device, display device 303, input mechanisms 304 and communication interface 305 for communicatively coupling to communication network 104. Processor 301 is configured with software and/or other logic, including but not limited to, inventory control adjustment logic module 105 to perform one or more processes, steps and other functions described with implementations, including as described by FIGS. 1 through 4 herein. Processor 301 may process information and instructions stored in memory 302, such as provided by a random access memory (RAM) or other dynamic storage device, for storing information and instructions which are executable by processor 301. Memory 302 also may be used for storing temporary variables or other intermediate information during execution of the instructions by processor 301. Memory 302 may also include the ROM or other static storage device for storing static information and instructions for processor 301. In one embodiment, a database server or other storage device, such as a magnetic disk or optical disk, communicatively coupled with server 101, may be provided for storing information and instructions accessible to server 101. Communication interface 305 enables server 101 to communicate with one or more communication networks 104 (e.g., cellular network) through use of the network link (wireless or wired). Using the network link, server 101 can communicate with mobile computing devices 102a-n.

Inventory control adjustment logic module 105 of inventory control server 101 may include instructions stored in memory 302 that constitute sub-modules, including mobile device localization module 305, inventory records comparison module 306, and outlier inventory item adjustment module 307. The term outlier as used herein is contemplated to include not just a spatial outlier attribute, such as when the inventory item is in a spatial location that differs from an expected, or nominal, placement position in a store or warehouse, but also to also include outlier quality attributes, such as when a condition of the inventory item appears to not conform to expectations or quality standards expected by a customer, for instance when in a damaged, broken or otherwise undesirable condition.

Processor 301 uses executable instructions stored in mobile device localization module 305 to localize the mobile device to a location within the bounded area based on accessing a fingerprint data mapping of the bounded area. The area may be an indoor area within a shopping mall, an airport, a warehouse, a university, or any at least partially enclosed building. In embodiments, the fingerprint data, which may be stored at server 101 and made accessible for downloading to mobile devices 102a-n, includes respective time-stamps, whereby the orientation, the magnetic field strength and direction, the received wireless signal strength, the barometric pressure, and the position data can be time-correlated for any given position along a trajectory or trajectory segment of the mobile devices, in accordance with the respective time-stamps. Additionally, when the sampling times and sampling rates applied in acquiring the fingerprint mapping data are different, the signal and sensor information as measured may be time-averaged across particular periods of time, with the time-averaged value being used to represent the signal information at any given instance of time within that particular period of time in which the signal information is time-averaged. The mobile device may localized based on one or more of the orientation, a magnetic field strength and direction, a received wireless communication signal strength, and a barometric pressure in conjunction with the fingerprint map data for the bounded area. The fingerprint map data may further include respective time-stamps whereby the orientation, the magnetic field strength and direction, the received wireless signal strength, and the barometric pressure are correlated in accordance with the respective time-stamps.

Processor 301 uses executable instructions stored in inventory records comparison module 306 to designate, or classify, the inventory item as an outlier inventory item based on the comparison the inventory item data value and the localized position of mobile device 102 with a set of data values of the inventory control record associated with the inventory item. For instance, designating the inventory item as an outlier inventory item when the nominal location according to inventory records for the inventory item does not match, or coincide with, the actual location of the item as determined from localizing mobile device 102. Based on receiving a further data value from scanning mobile device 102, identifying the item as damaged or otherwise non-conforming to customer or store expectations, designating the inventory item as an outlier inventory item based on that additional data value even when the nominal location matches the actual as-localized location.

Processor 301 uses executable instructions stored in outlier inventory item adjustment module 307 to adjust the inventory control record of that outlier item to reflect or conform with the actual position corresponding to that of localized mobile device 102. In other words, a data field of the inventory control record specifying a nominal, or expected, position of the inventory item newly designated as an outlier inventory, item may be modified to instead specify the new location in that data field that is consistent with the position to which mobile device 102 is localized. The terms position or location as used herein refers to a coordinate location, which may be expressed in local or global (X, Y) coordinate terms. In some embodiments, the coordinates may further include a Z coordinate representing a height, for example associated with a given floor within a multi-floor building, and thus expressed in (X, Y, Z) coordinate terms.

In one embodiment, a remedial action may be deployed within the bounded area that addresses the designating of the inventory item as an outlier inventory item. The remedial action may be to remove the inventory item from the outlier physical location and relocate it to the pre-designated or nominal location. In another variation, rather than re-locating the inventory item from its actual location to its expected or nominal location, in response to a customer query for the item, responding to same by providing the outlier physical location, or a marker for the latter such as an aisle number and a bin number. In the case of a damaged or otherwise non-conforming item, the item may be quarantined pending a final disposition as non-conforming in terms of quality or customer-expectation standards.

In some variations, an acknowledgement via a push notification may be sent to the mobile device that provided scanning of the inventory item resulting in the inventory update, or adjustment, to inventory control records. The push notification may include a commercial coupon having a redeemable financial value in yet another embodiment.

### Methodology

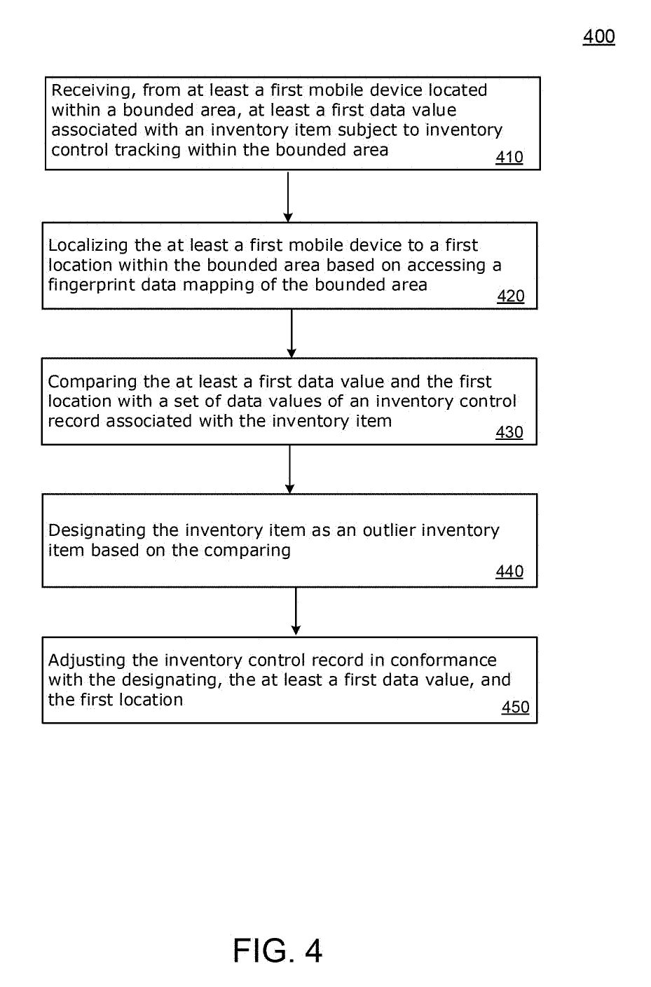

FIG. 4 illustrates, in an example embodiment, a method of operation 400 of inventory control adjustment system 100. In describing examples of FIG. 4, reference is made to the examples of FIGS. 1-3 for purposes of illustrating suitable components or elements for performing a step or sub-step being described.

Examples of method steps described herein are related to the use of inventory control server 101, variously referred to herein as server 101, for implementing the techniques described herein. According to one embodiment, the techniques are performed by inventory control adjustment logic module 105 of server 101 in response to the processor 301 executing one or more sequences of software logic instructions that constitute inventory control adjustment logic module 105. In embodiments, inventory control adjustment logic module 105 may include the one or more sequences of instructions within sub-modules including mobile device localization module 305, inventory records comparison module 306 and outlier inventory item adjustment module 307. Such instructions may be read into memory 302 from machine-readable medium, such as memory storage devices. Execution of the sequences of instructions contained in mobile device localization module 305, inventory records comparison module 306 and outlier inventory item adjustment module 307 of inventory control adjustment logic module 105 in memory 302 causes processor 301 to perform the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions.

At step 410, using the executable instructions of inventory control adjustment logic module 105 in conjunction with mobile device localization module 106 of a mobile device navigation application installed on mobile device 102, receiving, from mobile device 102 located within a bounded area subject to inventory control and tracking of inventory items therein. The bounded area may be such as. A first data value may be associated with the inventory item, such as a unique item identifier for inventory control and tracking of the item. The mobile device acquires the data value, such as unique identifier for the inventory item, based upon scanning a barcode, or using an RFID tag of the inventory item. The inventory control record for the inventory item, hosted at server 105 in one embodiment, may further include a set of data values specifying attributes for the inventory item, such as another data value that specifies a nominal location of the inventory item. The method may further include receiving, from the mobile device, a second data value associated with the inventory item, the second data value identifying the inventory item as one of damaged and non-conforming, or unfit for use.

In embodiments, the fingerprint data of the bounded area, also referred to herein as the fingerprint mapping data, which may be stored in, or communicatively accessible to, server 101 further includes respective time-stamps, whereby the orientation and other inertial sensor data, the magnetic field strength and direction, the received wireless signal strength, the barometric pressure, and the position data can be time-correlated with respect to any given position along a trajectory or trajectory segment of the mobile devices in the bounded area, in accordance with the respective time-stamps. Additionally, given that sampling times and sampling rates used in creating the fingerprint map of the bounded area may be different, the signal and sensor information as measured during the mapping may be time-averaged across particular periods of time, with the time-averaged value being used to represent the signal information at any given instance of time within that particular period of time in which the signal information is time-averaged.

At step 420, using the executable instructions of mobile device localization module 305, localizing the mobile device to a first location within the bounded area based on accessing a fingerprint data mapping of the bounded area. The mobile device may be localized based on one or more of an orientation, a magnetic field strength and direction, a received wireless communication signal strength, and a barometric pressure in conjunction with the fingerprint map data for the bounded area. The fingerprint map data may further include respective time-stamps whereby the orientation, the magnetic field strength and direction, the received wireless signal strength, and the barometric pressure are correlated in accordance with the respective time-stamps.

At step 430, using the executable instructions of inventory records comparison module 306, comparing the as-localized position of mobile device 102 with a set of data values of the inventory control record associated with the inventory item. For instance, the actual position of the inventory item in accordance with the as-localized position of mobile device 102 may be compared to determine if they match or coincide.

At step 440, using further executable instructions of inventory records comparison module 306, designating, or classifying, the inventory item as an outlier inventory item based on the comparison the inventory item data value and the localized position of mobile device 102 with a set of data values of the inventory control record associated with the inventory item. For instance, designating the inventory item as an outlier inventory item when the nominal location according to inventory records for the inventory item does not match the actual location of the item as determined from localizing mobile device 102. Based on receiving a further data value from scanning mobile device 102, identifying the item as damaged or otherwise non-conforming to customer or store expectations, designating the inventory item as an outlier inventory item based on that additional data value even when the nominal location matches the actual as-localized location.

At step 450, using the executable instructions of outlier inventory item adjustment module 307, adjusting the inventory control record in conformance with the designating, the at least a first data value, and the first location. For instance, the inventory records for the item may be updated to reflect the actual, as-localized, location, or an update regarding quality or non-conforming status of the item.

In one embodiment, a remedial action may be deployed within the bounded area that addresses the designating of the inventory item as an outlier inventory item. The remedial action may be to remove the inventory item from the outlier physical location and relocate it to the pre-designated or nominal location. In another variation, rather than re-locating the inventory item from its actual location to its expected or nominal location, in response to a customer query for the item, responding to same by providing the outlier physical location, or a marker for the latter such as an aisle number and a bin number. In the case of a damaged or otherwise non-conforming item, the item may be quarantined pending a final disposition as non-conforming in terms of quality or customer-expectation standards.

In some variations, an acknowledgement via a push notification may be sent to the mobile device that provided scanning of the inventory item resulting in the inventory update, or adjustment, to inventory control records. The push notification may include a commercial coupon having a redeemable financial value in yet another embodiment.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

1. A method of tracking an inventory item in a bounded area to manage location of the inventory item in the bounded area, the method executed in a processor of a server computing device and comprising:
initiating acquisition of fingerprint data pertaining to the bounded area by a mobile device located within the bounded area on occurrence an event at the mobile device, the event including scanning of an identifier associated with the inventory item by the mobile device;
receiving, from the mobile device, at least a first data value associated with the inventory item and a second data value associated with the inventory item, the second data value identifying the inventory item as one of damaged and non-conforming, wherein the first data value and the second data value are provided upon event occurrence at the mobile device;
localizing, using the processor in conjunction with a set of sensor devices of the mobile device, the mobile device to a first location within the bounded area based on accessing a fingerprint data mapping of the bounded area and at least one of an orientation, a magnetic field strength and direction, a received wireless communication signal strength, and a barometric pressure in conjunction with the fingerprint data, wherein the fingerprint data further includes respective time-stamps whereby the orientation, the magnetic field strength and direction, the received wireless signal strength, and the barometric pressure are correlated for a position along a trajectory the mobile device in accordance with respective time-stamps;
comparing, using the processor, the at least a first data value and the first location with a set of data values of the inventory control record associated with the inventory item; and
based on comparing, managing the inventory item in the bounded area, wherein managing includes at least one of an updating an actual position of the inventory item, based on the comparison and localization, and designating the inventory item as an outlier inventory item, based on the second data value.

2. The method of claim 1 wherein the bounded area comprises an indoor area within at least one of a commercial store, a warehouse, an airport facility, a medical facility, a university campus facility and an at least partially enclosed building.

3. The method of claim 1 wherein the mobile device acquires the first data value associated with the inventory item based upon at least one of scanning a barcode, and using an RFID tag, of the inventory item.

4. The method of claim 1 wherein the set of data values of the inventory control record includes a data value specifying a nominal location of the inventory item, and the comparing further comprises comparing the nominal location for the inventory item with the first location.

5. The method of claim 4, wherein managing comprises designating the inventory item as outlier inventory item when the nominal location does not match the first location.

6. (canceled)

7. (canceled)

8. The method of claim 1, wherein managing comprises deploying a remedial action within the bounded area that addresses the designating of the outlier inventory item.

9. The method of claim 1, wherein managing comprises dispatching, to the at least one mobile device, a push notification in acknowledgement of the receiving.

10. The method of claim 9 wherein the push notification includes a commercial coupon having a redeemable financial value.

11. A server computing system for tracking an inventory item in a bounded area to manage a location of the inventory item in the bounded area, the server system comprising:
a processor; and
a memory storing a set of instructions, the instructions executable in the processor to:
initiate acquisition of fingerprint data pertaining to the bounded area by a mobile device located within the bounded area on occurrence an event at the mobile device, the event including scanning of an identifier associated with the inventory item by the mobile device;
receive, from the mobile device, at least a first data value associated with the inventory item and a second data value associated with the inventory item, the second data value identifying the inventory item as one of damaged and non-conforming, wherein the first data value and the second data value are provided upon event occurrence at the mobile device;
localize, using the processor in con unction with a set of sensor devices of the mobile device, the mobile device to a first location within the bounded area based on accessing a fingerprint data mapping of the bounded area and at least one of an orientation, a magnetic field strength and direction, a received wireless communication signal strength, and a barometric pressure in conjunction with the fingerprint data, wherein the fingerprint data further includes respective time-stamps whereby the orientation, the magnetic field strength and direction, the received wireless signal strength, and the barometric pressure are correlated for a position along a trajectory the mobile device in accordance with respective time-stamps;
compare, using the processor, the at least a first data value and the first location with a set of data values of the inventory control record associated with the inventory item;
based on the comparing, manage the position of the inventory item in the bounded area, wherein managing includes at least one of an updating an actual position of the inventory item, based on the comparison and localization, and designating the inventory item as an outlier inventory item, based on the second data value.

12. The server computing system of claim 11 wherein the bounded area comprises an indoor area within at least one of a commercial store, a warehouse, an airport facility, a medical facility, a university campus facility and an at least partially enclosed building.

13. The server computing system of claim 11 wherein the mobile device acquires the first data value associated with the inventory item based upon at least one of scanning a barcode, and using an RFID tag, of the inventory item.

14. The server computing system of claim 13 wherein the set of data values of the inventory control record includes a data value specifying a nominal location of the inventory item, and the comparing further comprises comparing the nominal location for the inventory item with the first location.

15. The server computing system of claim 14 further comprising instructions executable to designate the inventory item as an outlier inventory item when the nominal location does not match the first location to manage the location of the inventory item.

16. (canceled)

17. (canceled)

18. The server computing system of claim 11 further comprising instructions executable to deploy a remedial action within the bounded area that addresses the designating of the outlier inventory item to manage the location of the inventory item.

19. The server computing system of claim 11, wherein managing the location of the inventory item comprises, dispatching to the at least one mobile device, a push notification in acknowledgement of the receiving.

20. The server computing system of claim 19 wherein the push notification includes a commercial coupon having a redeemable financial value.
